(19) United States
(12) Patent Application Publication
(10) Pub. No.: US 2024/0354086 A1
(43) Pub. Date: Oct. 24, 2024

(54) SYSTEMS AND METHODS FOR CAPTURING DEPLOYMENT DETAILS OF AN APPLICATION

(71) Applicant: Engineer.ai Corp., Salt Lake City, UT (US)

(72) Inventors: Sachin Dev Duggal, Salt Lake City, UT (US); Joseph Rifkin, Salt Lake City, UT (US); Utsav Preet, London (GB); Rohan Patel, London (GB); Priyanka Kochhar, London (GB)

(73) Assignee: Engineer.ai Corp., Salt Lake City, UT (US)

(21) Appl. No.: 18/304,336

(22) Filed: Apr. 20, 2023

(51) Int. Cl. G06F 8/60; G06F 8/36; G06F 8/77

(52) U.S. Cl. CPC G06F 8/60; G06F 8/36; G06F 8/77

(57) ABSTRACT

Systems and methods for capturing deployment details of an application is disclosed. The system includes a processor coupled to a memory. The processor is configured to receive a request for creating the application. The request includes one or more features. The processor is further configured to generate one or more building blocks for the one or more features once developed. One building block is generated for each feature. The processor is further configured to deploy the one or more building blocks to a domain with which the application is registered. In addition, the processor is configured to generate a deployment report once the one or more building blocks have been deployed.

### FIELD

This disclosure relates to project management, and more particularly to systems and methods for capturing and presenting deployment details of developed applications to the developers.

### BACKGROUND

With the rise of the internet over the last decade, many people rely on online sources (for example, websites, and mobile applications) for performing work and business-related activities. Online platforms are elements used for building a successful brand. People across multiple locations can learn sufficient information about a business/organization/firm by browsing through their website/online platform. Deployment of websites/online platforms enables content present therein to be presented to multiple users. However, while deploying multiple websites, transparency between the website developers and website/online platform is less as people are not much aware of how the deployments are happening. Also, in case a deployment takes time, the developers have to be made aware of the reason for this delay.

Further, when developing websites/online platforms, people may need help knowing which features or content to add to their websites. Platforms are available that assist people in developing websites even if they have no background experience or coding/programming experience. However, if people want to add additional content/features or make significant changes to the look of the website/online platform, they may need to contact specialized designers or third-party sources. Thus, design customization is a challenge that some people may face while developing their website/online platform.

### SUMMARY

The disclosed subject matter relates to a system for capturing deployment details of an application. The system includes a processor coupled to a memory. The processor is configured to receive a request for creating the application. The request includes one or more features. The processor is further configured to generate one or more building blocks for the one or more features once developed. One building block is generated for each feature. The processor is further configured to deploy the one or more building blocks to a domain with which the application is registered. In addition, the processor is configured to generate a deployment report once the one or more building blocks have been deployed.

The disclosed subject matter also relates to a method for capturing deployment details of an application. The method includes receiving a request for creating the application. The request includes one or more features. The method includes generating one or more building blocks for the one or more features once developed. One building block is generated for each feature. The method further includes deploying the one or more building blocks to a domain with which the application is registered. In addition, the method further includes generating a deployment report once the one or more building blocks have been deployed.

The disclosed subject matter also relates to a computer readable storage medium having data stored therein representing software executable by a computer, the software comprising instructions that, when executed, cause the computer readable storage medium to perform receiving a request for creating the application. The request includes one or more features. The instructions further cause the computer readable storage medium to perform generating one or more building blocks for the one or more features once developed. One building block is generated for each feature. The instructions further cause the computer readable storage medium to perform deploying the one or more building blocks to a domain with which the application is registered. In addition, the instructions cause the computer readable storage medium to perform generating a deployment report once the one or more building blocks have been deployed.

The disclosed subject matter further relates to a system for developing an application. The system includes a processor coupled to a memory. The processor is configured to receive a request for creating the application. The request includes one or more features and one or more building blocks that implement the one or more features. The processor is further configured to determine whether at least one building block implemented for at least one feature of the application being developed currently has been implemented in a previously developed application. The processor is further configured to retrieve development details of the at least one building block of the previously developed application from a code repository. In addition, the processor is configured to use the development details of the at least one building block generated for the previously developed application to develop the at least one feature in the application being developed currently.

The disclosed subject matter also relates to a method for developing an application. The method includes receiving a request for creating the application. The request includes one or more features and one or more building blocks that implement the one or more features. The method further includes determining whether at least one building block implemented for at least one feature of the application being developed currently has been implemented in a previously developed application. The method further includes retrieving development details of the at least one building block of the previously developed application from a code repository. In addition, the method includes using the development details of the at least one building block generated for the previously developed application to develop the at least one feature in the application being developed currently.

The disclosed subject matter also relates to a computer readable storage medium having data stored therein representing software executable by a computer, the software comprising instructions that, when executed, cause the computer readable storage medium to perform receiving a request for creating an application. The request includes one or more features and one or more building blocks that implement the one or more features. The instructions further cause the computer readable storage medium to perform determining whether at least one building block implemented for at least one feature of the application being developed currently has been implemented in a previously developed application. The instructions further cause the computer readable storage medium to perform retrieving development details of the at least one building block of the previously developed application from a code repository. The instructions further cause the computer readable storage medium to perform using the development details of the at least one building block generated for the previously developed application to develop the at least one feature in the application being developed currently. The instructions further cause the computer readable storage medium to perform recommending one or more additional features suitable to add to the application being developed currently. In addition, the instructions cause the computer readable storage medium to perform presenting the recommended one or more additional features to one or more developers currently developing the application by at least one of a written message, voice message, and an email message while they are working.

In addition, the disclosed subject matter relates to a system for obtaining features for developing an application. The system includes a processor coupled to a memory. The processor is configured to receive a request for creating the application. The processor is further configured to determine one or more features suitable to add to the application based on one or more parameters. The processor is further configured to retrieve the one or more features from one or more sources using an application programming interface (API). In addition, the processor is configured to add the one or more features to the application upon an acknowledgement from one or more authorized persons.

The disclosed subject matter also relates to a method for obtaining features for developing an application. The method includes receiving a request for creating the application. The method further includes determining one or more features suitable to add to the application based on one or more parameters. The method further includes retrieving the one or more features from one or more sources using an application programming interface (API). In addition, the method includes adding the one or more features to the application upon an acknowledgement from one or more authorized persons.

The disclosed subject matter also relates to a computer readable storage medium having data stored therein representing software executable by a computer, the software comprising instructions that, when executed, cause the computer readable storage medium to perform receiving a request for creating the application. The instructions further cause the computer readable medium to perform determining one or more features suitable to add to the application based on one or more parameters. The instructions further cause the computer readable medium to perform retrieving the one or more features from one or more sources using an application programming interface (API). In addition, the instructions cause the computer readable medium to perform adding the one or more features to the application upon an acknowledgement from one or more authorized persons.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic illustrating the computing components that may be used to implement various features of embodiments described in the disclosed subject matter.

FIG. 6 is a schematic illustrating a system in an embodiment of the disclosed subject matter.

FIG. 7 is a schematic illustrating an exploded view of the server of the system of FIG. 6 in an embodiment of the disclosed subject matter.

FIG. 8 is a flow diagram illustrating a method for capturing deployment details of an application in an embodiment of the disclosed subject matter.

FIG. 9 is a flow diagram illustrating a method for developing an application in an embodiment of the disclosed subject matter.

FIG. 10 is a flow diagram illustrating a method for obtaining features for developing an application in an embodiment of the disclosed subject matter.

### DETAILED DESCRIPTION

Embodiments, of the present disclosure, will now be described with reference to the accompanying drawing.

Embodiments are provided so as to convey the scope of the present disclosure thoroughly and fully to the person skilled in the art. Numerous details, are set forth, relating to specific components, and methods, to provide a complete understanding of embodiments of the present disclosure. It will be apparent to the person skilled in the art that the details provided in the embodiments may not be construed to limit the scope of the present disclosure. In some embodiments, well-known processes, well-known apparatus structures, and well-known techniques are not described in detail.

The terminology used, in the present disclosure, is for the purpose of explaining a particular embodiment and such terminology may not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof. The particular order of steps disclosed in the method and process of the present disclosure is not to be construed as requiring their performance as described or illustrated. It is also to be understood that additional or alternative steps may be employed.

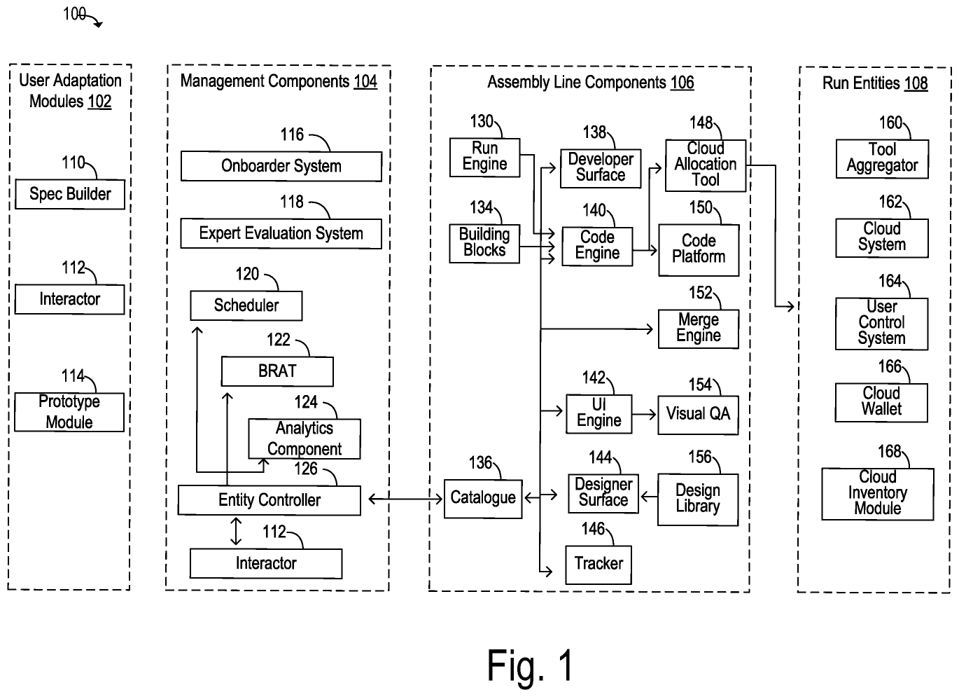

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. user adaptation modules 102 may intelligently link a user to various entities of the software building system 100.

The user adaptation modules 102 may include a specification builder 110, an interactor 112 system, and the prototype module 114. They may be used to guide a user through a process of building software and managing a software project. The specification builder 110, the interactor 112 system, and the prototype module 114 may be used concurrently and/or link to one another. For instance, the specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

The specification builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to reduce the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return results.

The prototype module 114 may use a secondary machine learning algorithm to select a likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a good fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with critique and provide the onboarding system 116 with metrics with it can use to allocate the experts on future tasks.

Scheduler 120 keeps track of overall progress of a project and provides experts with job start and job completion estimates. In a complex project, some expert developers may be expected to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating developer assignments for all available parallel workstream across multiple projects. BRAT 122 system allows expert developers to be efficiently managed to reduce cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the top experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, the building block components 134 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the throughput based on the volume of builds coming in through a queue system. This stateless architecture may also enable support for multiple languages in a plug & play manner.

The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

The visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services by users to build, run and scale their software project. For instance, it may aggregate software services from payment gateways and licenses such as Office 365. User accounts may be automatically provisioned for services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over all features of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user has to set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

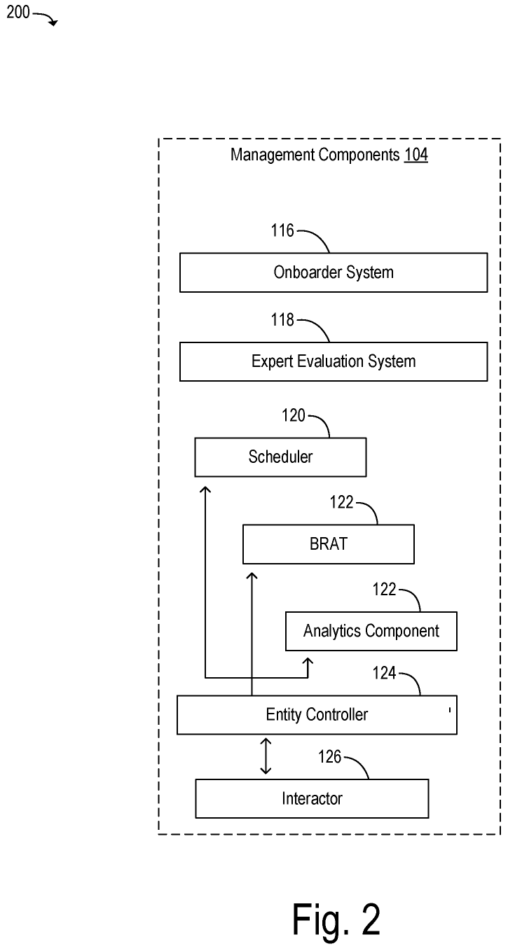

Referring to FIG. 2, FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

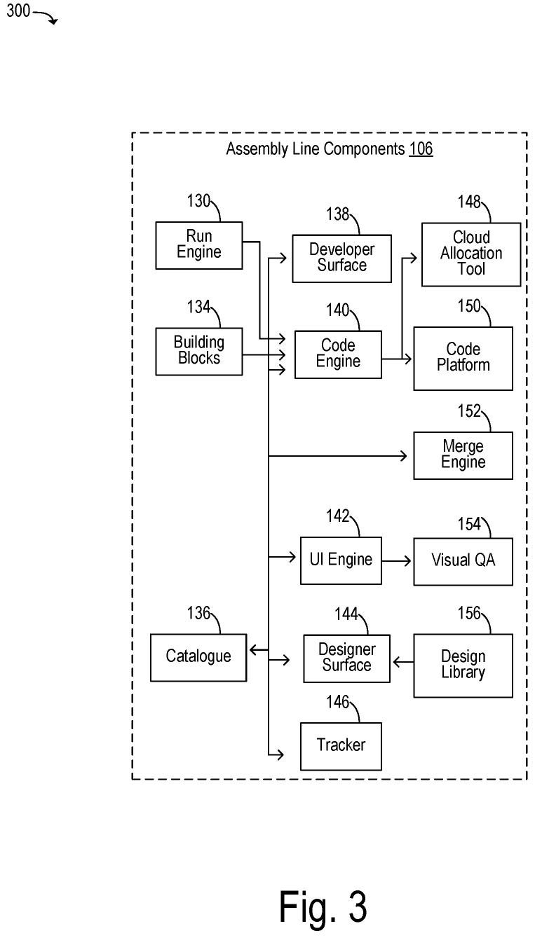

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

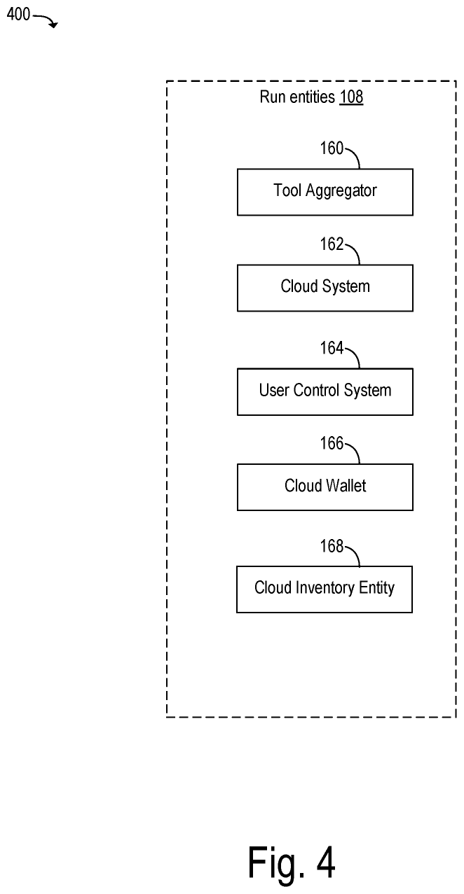

Referring to FIG. 4, FIG. 4 is a schematic 400 illustrating an embodiment of the run entities 108 of the software building system. The run entities 108 provides a user with 3rd party tools and services, inventory management, and cloud services in a scalable system that can be automated to manage a software project. In an exemplary embodiment, the run entities 108 is a cloud-based system that provides a user with all tools to run a project in a cloud environment.

For instance, the tool aggregator 160 automatically subscribes with appropriate 3rd party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

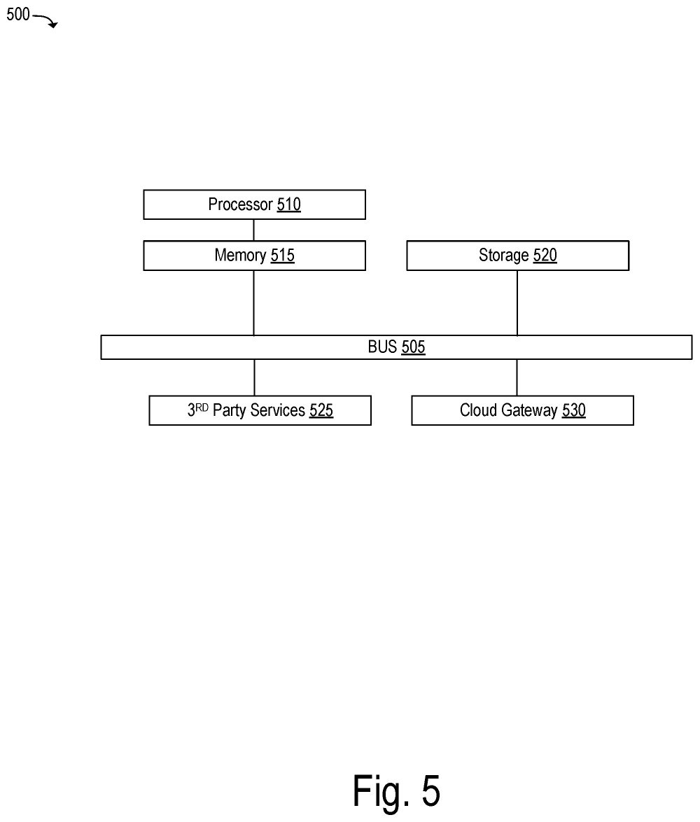

Referring to FIG. 5, FIG. 5 is a schematic illustrating a computing system 500 that may be used to implement various features of embodiments described in the disclosed subject matter. The terms components, entities, modules, surface, and platform, when used herein, may refer to one of the many embodiments of a computing system 500. The computing system 500 may be a single computer, a co-located computing system, a cloud-based computing system, or the like. The computing system 500 may be used to carry out the functions of one or more of the features, entities, and/or components of a software project.

The exemplary embodiment of the computing system 500 shown in FIG. 5 includes a bus 505 that connects the various components of the computing system 500, a processor 510 coupled to a memory 515, and a storage 520. The processor 510 is an electronic circuit that executes instructions that are passed to it from the memory 515. Executed instructions are passed back from the processor 510 to the memory 515. The interaction between the processor 510 and memory 515 allow the computing system 500 to perform computations, calculations, and various computing to run software applications.

Examples of the processor 510 include central processing units (CPUs), graphics processing units (GPUs), field programmable gate arrays (FPGAs), complex programmable logic devices (CPLDs), and application specific integrated circuits (ASICs). The memory 515 stores instructions that are to be passed to the processor 510 and receives executed instructions from the processor 510. The memory 515 also passes and receives instructions from all other components of the computing system 500 through the bus 505. For example, a computer monitor may receive images from the memory 515 for display. Examples of memory include random access memory (RAM) and read only memory (ROM). RAM has high speed memory retrieval and does not hold data after power is turned off. ROM is typically slower than RAM and does not lose data when power is turned off.

The storage 520 is intended for long term data storage. Data in the software project such as computer readable specifications, code, designs, and the like may be saved in a storage 520. The storage 520 may be stored at any location including in the cloud. Various types of storage include spinning magnetic drives and solid-state storage drives.

The computing system 500 may connect to other computing systems in the performance of a software project. For instance, the computing system 500 may send and receive data from 3rd party services such as Office 365 and Adobe. Similarly, users may access the computing system 500 via a cloud gateway 530. For instance, a user on a separate computing system may connect to the computing system 500 to access data, interact with the run entities 108, and even use 3rd party services 525 via the cloud gateway.

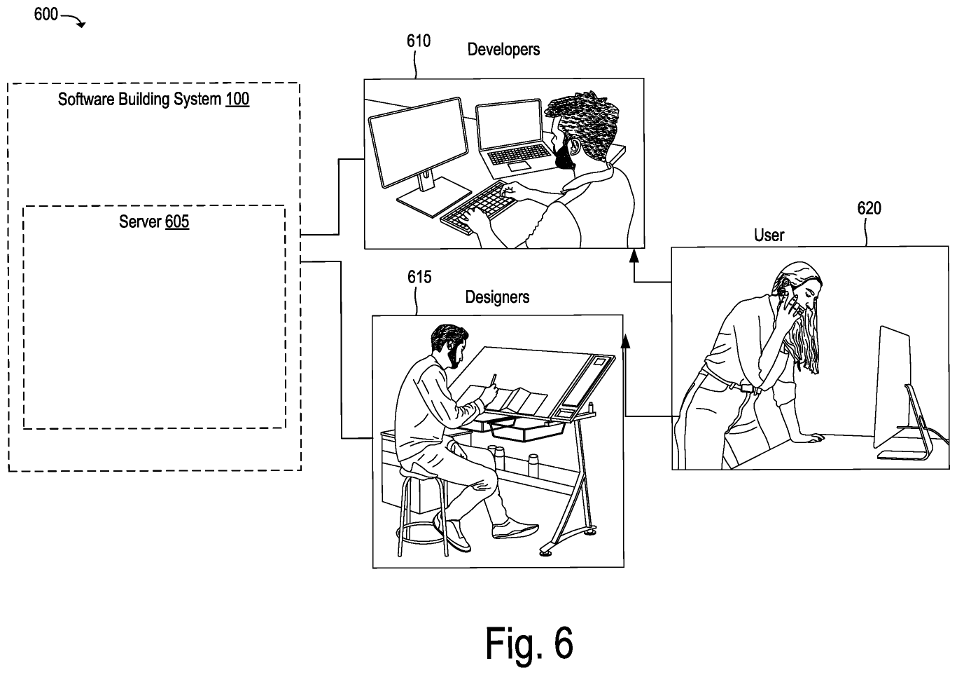

Referring to FIG. 6, FIG. 6 is a schematic diagram of a system 600 in an embodiment of the disclosed subject matter. In an exemplary embodiment, the system 600 comprises the software building system 100, one or more users 620, one or more developers 610, and one or more designers 615. In the embodiment shown for the system 600, the software building system 100 comprises a server 605. The server 605 may be a computing system 500.

In the exemplary embodiment shown in FIG. 6, the server 605 is in communication with one or more users 620, one or more developers 610, and one or more designers 615. Various embodiments may include additional personnel or computing resources that produce code, content, or the like for the software application. For example, the server 605 may be in communication with one or more quality assurance engineers to assemble, test, and package the software application.

In an exemplary embodiment, the server 605 may transfer allocating units to the users 620. The users 620, as used herein, may be referred to an individual person, small business owner/manager, large business owner/manager, hotel manager, restaurant manager, and the like. The users 620 may distribute the allocating units to various personnel, computing resources, or other services to work on the software application. In an exemplary embodiment, allocating units may be referred to as tokens, points, or the like. As used herein, the allocating units are commonly referred to as points.

In an exemplary embodiment, the users 620 may distribute points to developers 610 and designers 615. The developers 610, as used herein, may be referred to as experts, developer experts, coders, software engineers, engineers, and the like. In various embodiments, the one or more developers 610 may be supplied by an onboarding system 116. In various embodiments, the users 620 contact and selects the one or more developers 610.

In an exemplary embodiment, the BRAT 122 may determine the one or more developers 610 for a software project. In one implementation, the BRAT 122 may determine the one or more developers 610 for the users 620 based on multiple qualities of a software application and/or multiple software application visions. For instance, the BRAT 122 may determine the one or more developers 610 for a small-size software application, a medium-sized software application, and a large medium-sized software application. In another instance, the BRAT 122 may determine the one or more developers 610 for a consumer-based software application and an industry-based software application where a consumer-based software application has a focus on large volume consumer communication and an industry-based software application has a focus on intimate communication with a small number of industries.

The designers 615, as used herein, may be referred to as artists, web designers, and the like. The designers 615 may have different skill levels and different skill areas. In an exemplary embodiment, the BRAT 122 may provide the one or more designers 615 along with their talent set. A user may use the provided information on designers to allocate resources to designers 615 in a way that promotes the users 620 vision of the software application.

The system 600 allows the users 620 freedom to distribute points according to their vision and limited resources for the software application project. Accordingly, the system 600 maximizes creativity at a high level by allowing the users 620 strategic control over high-level management decisions in the software project. The users 620 is not limited to arbitrary or abstract criteria for selecting developers or designers or how to allocate points to developers or designers. Even where the cloud allocation tool 148 determines a number of points for the users 620, the system 600 provides for the users 620 to distribute those points without limitations.

The distribution of points from the users 620 to developers 610, designers 615, or the like is a signal to the developers 610 and designers 615 to provide an amount of work commensurate with the number of points transferred. The server 605 may provide lower management level decisions to the developers 610, designers 615, or other personnel or computing resources based on the points allocated to them by the users 620. In an exemplary embodiment, the server 605 may provide payment to the developers 610 and designers 615 based on the points distributed to them.

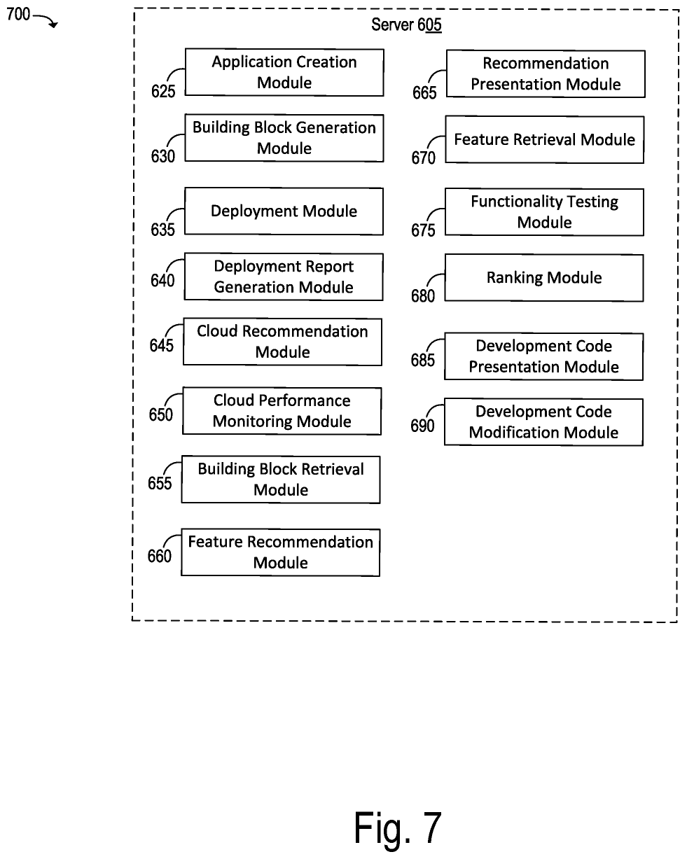

Referring to FIG. 7, FIG. 7 illustrates an exploded view 700 of the server 605 of the system 600 of FIG. 6 in an embodiment of the disclosed subject matter. As shown, the server 605 includes an application creation module 625, a building block generation module 630, a deployment module 635, a deployment report generation module 640, a cloud recommendation module 645, a cloud performance monitoring module 650, a building block retrieval module 655, a feature recommendation module 660, a recommendation presentation module 665, a feature retrieval module 670, a functionality testing module 675, a ranking module 680, a development code presentation module 685, and a development code modification module 690. The functionality of each module is explained in further detail below.

In an exemplary embodiment, the application creation module 625 receives a request for creating an application. The request for creating the application may be made by the one or more developers 610, one or more designers 615, or the one or more users 620. In an example, the application may include a website, a mobile application, a web application, and the like. The application may be created for personal purposes, business purposes, entertainment purposes, legal purposes, and the like. The application creation module 625 allows the one or more users 620 to create a build card by first selecting at least one template and usage of the application. For instance, the usage may include e-commerce, medical, hotel, restaurant, sports, and the like. Once the template and usage are selected, they will then be presented with a cost estimate, for which they would have to make an initial payment. Further, the request includes one or more features. In an example, the one or more features may include a login screen, dashboard, login page, and the like. Once the build card is created and the one or more features are finalized, the server 605 assigns one or more developers 610 and one or more designers 615 to develop the application requested to be created by the application creation module 625.

In an exemplary embodiment, the building block generation module 630 generates one or more building blocks for the one or more features selected by the users 620. One building block is generated for each feature. Each building block is generated once the development of its corresponding feature is complete. The one or more building blocks are reusable pieces of code that implement partial functionalities of the one or more features assigned for each project. For example, the code may be written using C language, C++, Java, Phyton, or any appropriate programming language that is known to those skilled in the art.

In an exemplary embodiment, the deployment module 635 deploys the one or more building blocks generated by the building block generation module 630 to a domain with which the application is registered. In order for the building blocks to be deployed, the application has to be registered with an appropriate domain. Deployment of the application is performed once it has been tested and is ready for launch. Deployment is a process in which the application is delivered to one or more clients/customers in a ready state. The deployment module 635 may deploy the application to a test server, a testing machine, into a live environment, and the like. Before the application is pushed to the live environment, it is be deployed to the test server. The test server performs a final test/inspection to verify whether there are no errors or bugs in the application. Once the application has been fully tested on the test server, the deployment module 635 then deploys the application to the live environment where the users 620 and other people will be able to view and experience the application.

In an exemplary embodiment, the deployment report generation module 640 generates a deployment report once the deployment module 635 deploys the one or more building blocks of the features of the application. For instance, the deployment report may be generated in real-time or as soon as each building block has been deployed into the live application. The deployment report includes one or more details corresponding to each deployment conducted by the deployment module 635. In an example, the one or more details may include a deployment average duration during a specified duration, a deployment total duration during a specified duration, a deployment count during a specified duration, a deployment location during a specified duration, device used for deployment, and the like. The deployment report may be presented to the developers 610, designers 615, and users 620 via a tabular format, line graph, bar graph, pie chart, and the like. Such presentations allow the developers 610, designers 615, or users 620 to visualize a deployment pattern and figure out which deployments are taking longer than expected.

In an exemplary embodiment, the cloud recommendation module 645 recommends one or more cloud infrastructures for deploying the one or more building blocks based on the deployment report generated by the deployment report generation module 640. For instance, if the deployments carried out previously were from cloud infrastructure A and few issues arose in the deployment that was captured in the generated deployment report, the cloud recommendation module 645 may then recommend other cloud infrastructures to opt for to improve the deployment of capacity. For instance, the cloud recommendation module 645 may make the cloud infrastructure recommendations based on one or more factors. The one or more factors may include supporting technologies, cost, previous deployment history, client requirements, reliability, and security.

The factor supporting technologies corresponds to cloud service infrastructures/providers that are able to support or cope with the application. In an example, if the application being developed is an e-commerce application, the cloud recommendation module 645 determines cloud infrastructures that have a suitable architecture, standards, and services that would be able to cope with the e-commerce application. The cloud recommendation module 645 also takes previous cloud infrastructures used and the deployment report generated by the deployment report generation module 640 while making the recommendations.

The factor cost corresponds to expenditures and fees to be spent while using the cloud infrastructure/provider. The cloud recommendation module 645 analyses expenditures made using previous cloud infrastructures as mentioned in the deployment report, and accordingly provides recommendations to reduce cost. The factor previous deployment history corresponds to one or more deployments carried out by the developers 610, designers 615, or users 620 for different applications. The cloud recommendation module 645 analyses the deployment durations and locations mentioned in the deployment report, compares those durations with standard durations of other cloud infrastructures, and accordingly makes the recommendations.

The factor client requirement corresponds to development details, a vision of the product/application, and goals that have been provided to the one or more developers 610 to develop the current application. Based on the inputs provided to the one or more developers 610, the cloud recommendation module 645 is capable of recommending one or more suitable cloud infrastructures to opt for.

In an exemplary embodiment, the cloud performance monitoring module 650 monitors a performance of at least one cloud infrastructure recommended by the cloud recommendation module 645 selected by the one or more developers 610 for deploying the one or more building blocks. The performance of the selected at least one cloud infrastructure may be monitored based on one or more parameters. In an example, the one or more parameters may include a load time of the application, a geographic location, a latency, a bandwidth, and the like.

The load time corresponds to an elapsed time taken by the application to perform at least one function requested by the developers 610, designers 615, or users 620. The cloud performance monitoring module 650 determines an average elapsed time taken for loading/performing of functions of the application and compares the average elapsed time with a load threshold. If the average elapsed time is less than or equal to the load threshold, this gives an indication that cloud infrastructure used for running and deploying the application is able to execute the functions in a timely manner. If the average elapsed time is greater that the load threshold, this may give an indication that the cloud infrastructure is performing slower than expected. In such a case, the cloud performance monitoring module 650 may communicate this information to the cloud recommendation module 645. The cloud recommendation module 645 may then chose to recommend other cloud infrastructures that may be able to execute the functions of the application within the load threshold range.

The one or more developers 610 or designers 615 working on the application may be across different geographic locations. The cloud performance monitoring module 650 monitors the performance and speed of the cloud service at each geographic location of the one or more developers 610 or designers 615 associated with building the application. In case the performance and speed is slow in few of the geographic locations, the cloud performance monitoring module 650 may communicate this information to the cloud recommendation module 645. The cloud recommendation module 645 may then chose to recommend other cloud infrastructures that may be able to execute the functions of the application with suitable speeds across multiple geographic locations.

The latency and bandwidth are used for evaluating transfer rates while using the cloud infrastructure. Latency refers to time delays between two or more points while transferring data and bandwidth refers to a range of one or more frequencies with which data is transferred between two or more points. The cloud performance monitoring module 650 monitors the latency and bandwidth between multiple points/modes in the cloud infrastructure, and compares the latency with a delay threshold and the bandwidth with a range threshold. The delay threshold and range threshold may be set based on a standard. In case the latency and bandwidth information is found to be below the thresholds, the cloud performance monitoring module 650 may communicate this information to the cloud recommendation module 645. The cloud recommendation module 645 may then choose to recommend other cloud infrastructures that may be able to perform with an improved bandwidth and reduced latencies.

In an exemplary embodiment, the building block retrieval module 655 firstly determines whether at least one building block implemented for at least one feature of the application being developed currently has been implemented in a previously developed application. In an example, the at least one feature may be a login feature. The building block retrieval module 655 analyses the current development details of this login feature and compares it with development details of a login feature previously developed. The one or more building blocks generated are stored in a code repository, and the building block retrieval module 655 is able to receive previously developed building blocks from here. The building block retrieval module 655 compares the development details of the login feature between the current application and previously developed application to determine matches.

If matches are determined, the building block retrieval module 655 then shares development details of the building block corresponding to the previously developed login feature retrieved from the code repository with the one or more developers 610. The one or more developers 610 may then use these development details while developing the login feature in their current application. Thus, the one or more developers 610 do not have to start from scratch while developing the login feature or other features, as they will be provided with previously developed details. This will save their time and effort while developing the features in the current application.

In an exemplary embodiment, the feature recommendation module 660 recommends one or more additional features to the one or more developers 610 to add to the application. The one or more additional features may be recommended to the one or more developers 610 while they are working. In an example, if the one or more developers 610 are developing an e-commerce application and the one or more features being developed include a registration feature, a search feature, a product showcase feature, a detailed product information feature, a product review feature, a purchase feature, and the like. The feature recommendation module 660 may then recommend adding additional features such as a voice assistant feature, a Wishlist feature, a customer support feature, and the like.

These additional features recommendations may be made based on an analysis of one or more parameters. For instance, the one or more parameters may include current trends, previously developed applications, feedback from clients/customers, costs, value to the application, and the like. The additional features may also be recommended based on the deployment report generated by the deployment report generation module 640. In an example, if the deployment report mentions that an additional store bucket space is 20 Gb, then the feature recommendation module 660 has to make sure that the bucket space/storage space occupied by each recommended additional feature does not exceed 20 Gb.

The current trends corresponds to recent changes or developments made in similar or previously developed applications. The feature recommendation module 660 analyzes different features being developed in similar applications to the one being developed currently. If few features present in the similar/previously developed applications are of value and have become increasingly used, the feature recommendation module 660 recommends to the one or more developers 610 to add such features to the current application that they are developing. The feature recommendation module 660 also analyzes feedback or inputs received for different features developed in the similar/previously developed applications. If few features present in the similar/previously developed application have received good feedback/ratings, the feature recommendation module 660 recommends to the one or more developers 610 to add such features to the current application that they are developing.

Further, the cost and value to the application corresponds to investments made by the one or more users 620 or entity who have requested the one or more developers 610 or designers 615 to create the application. The value of the application corresponds to the importance that the application holds for the one or more users 620 or entity. In an example, if the one or more users 620 have invested a good amount of time and money in the application, and the application is proposed to be launched in multiple geographic locations, this gives an indication that the application being developed currently is of high value and of a high quality development product. The feature recommendation module 660 then recommends such additional features that would hold high value, would benefit the application, and would attract a good customer base.

In an exemplary embodiment, the recommendation presentation module 665 presents the additional features recommended by the feature recommendation module 660 to the one or more developers 610 while they are working on the application or after the application has been developed. In an example, the recommended additional features may be presented to the one or more developers 610 via a written message, voice message, an email message, and the like simultaneously while they are working. For instance, the written message may be in a chat bot format that prompts a message to the one or more developers 610 in their device while they are working. In the e-commerce application example, the written message prompted may be “Have you thought of adding voice assistant feature?” or “Try adding a Wishlist feature to your application.”. The one or more developers 610 may then answer back to the prompted message in the chatbot to figure out more information regarding the additional recommended features.

Further, the voice message may be spoken out to the one or more developers 610 while they are working or after they have completed developing a portion or majority of the application. In the e-commerce application example, the voice message spoken out may be “Try adding voice assistant feature” or “How about adding a Wishlist feature to your application. Such voice messages may help grab the attention of the one or more developers 610 more quickly.

In an exemplary embodiment, the feature retrieval module 670 determines whether the building blocks corresponding to the additional features recommended by the feature recommendation module 660 are present in the code repository. The feature retrieval module 670 checks whether the building block generated for at least one additional feature has already been developed in a previously developed application/previously developed build card. If yes, the feature retrieval module 670 shares the development details of the building block corresponding to the previously developed application/previously developed build card with the one or more developers 610. The one or more developers 610 may choose to modify the development details provided to them in order to satisfy their requests. Thus, the feature retrieval module 670 is capable of searching for and providing development details of the additional features recommended by the feature recommendation module 660 if the additional features have already been developed previously. Thus, the one or more developers 610 do not have to spend time in understanding how to develop the additional features from scratch as the development details are provided to them, which they may also modify.

In case the development details of the additional features recommended by the feature recommendation module 660 are not present in the code repository, the feature retrieval module 670 retrieves the one or more features from one or more sources using an application programming interface (API). In an example, the application being developed by the one or more developers 610 may be an e-commerce application. The feature recommendation module 660 has recommended adding additional payment features (for example, Google Pay, Razorpay, etc.), and the building blocks corresponding to these additional payment features are not present in the code repository. The feature retrieval module 670 then uses APIs to retrieve these payment features from the source/third-party source. In an example, the APIs may include open APIs, partner APIs, internal APIs, composite APIs, and the like. The API first retrieves information from the build card created by the application creation module 625. Upon retrieval of the information, the API makes a call to the third-party source. Upon acknowledgement, the third-party source provides the information corresponding to the additional payment features. Thus, the feature retrieval module 670 is capable of automatically retrieving the additional features recommended by the feature recommendation module 660 with minimal customer intervention.

Once the additional features have been appropriately retrieved and verified by the one or more developers 610, the additional features are added to the application. The additional features may be added to the application upon an acknowledgement from one or more authorized persons. In an example, the one or more authorized persons may be the one or more users 620. The one or more developers 610 communicate the additional features recommended by the feature recommendation module 660 and their strategy to implement these additional features to the one or more users 620 for their thoughts and acknowledgement to proceed. Upon their consent, the one or more developers 610 may add the additional features to the application.

In an exemplary embodiment, the functionality testing module 675 tests a functionality of the one or more building blocks generated by the building block generation module 630 and stored in the code repository. The functionality testing module 675 tests whether the one or more features of the application developed by the one or more developers 610 works as per the software requests. Each feature is compared to its corresponding request for determining whether its output is consistent with the expectations of the one or more users 620. The functionality testing may be performed by providing one or more sample inputs and verifying whether the output of each sample input matches its actual/expected output. Based on the functionality testing, the functionality testing module 675 generates a functionality score for each tested building block. The functionality score may be represented as a percentage. The functionality score enables the one or more developers 610 and one or more users 620 to analyze and figure out which building blocks are performing to the expectations of the one or more users 620 and which building blocks are not yet performing up to the expectations. This will thus enable them to look back and modify the development of the features corresponding to those building blocks with a low functionality score.

In an exemplary embodiment, the ranking module 680 ranks the one or more features in an order to be developed based on one or more parameters. Some features of the application may be lengthy, complex, and of greater importance/significance when compared to other features of the application. Those features are made aware to the one or more developers 610 in advance so that they will be able to timely develop them and timely deliver the developed application. For instance, the one or more parameters analyzed for ranking the one or more features may include a value/importance of the feature, a value of the application, a deadline for developing the application, and the like.

In an exemplary embodiment, the development code presentation module 685 presents/shares the development code for each building block corresponding to each feature of the application to the one or more developers 610, one or more designers 615, and one or more users 620. The development code may be written using C language, C++, Java, Phyton, or any appropriate programming language that is known to those skilled in the art. The development code may be presented to the one or more developers 610 or one or more designers 615 simultaneously while they are working or after the feature has been partially developed or completely developed.

In an exemplary embodiment, the development code modification module 690 is configured to modify the development code previously written/developed by the one or more developers 610. The development code modification module 690 first receives one or more modifications made by the one or more developers 610 to at least one code for at least one feature. In an example, the one or more modifications may include adding new lines of code, removing previously inserted lines of code, adding new comments in the code, making changes in the functionality of the code, and the like. The one or more modifications made by the one or more developers 610 are then presented to the one or more users 620.

Once the one or more modifications have been implemented, the building block corresponding to the feature in which the code has been modified is updated. This updated building block is then automatically saved in the code repository. In an example, if feature A is modified then the building block A corresponding to feature A is modified. When saved in the code repository, the building block may be named as building block A1. Here, the code repository saves different versions of updates made in the building blocks for its corresponding features. This may be helpful for future purposes in situations where the one or more developers 610 or one or more users 620 would want to see the changes made or differences between the various versions of the building blocks.

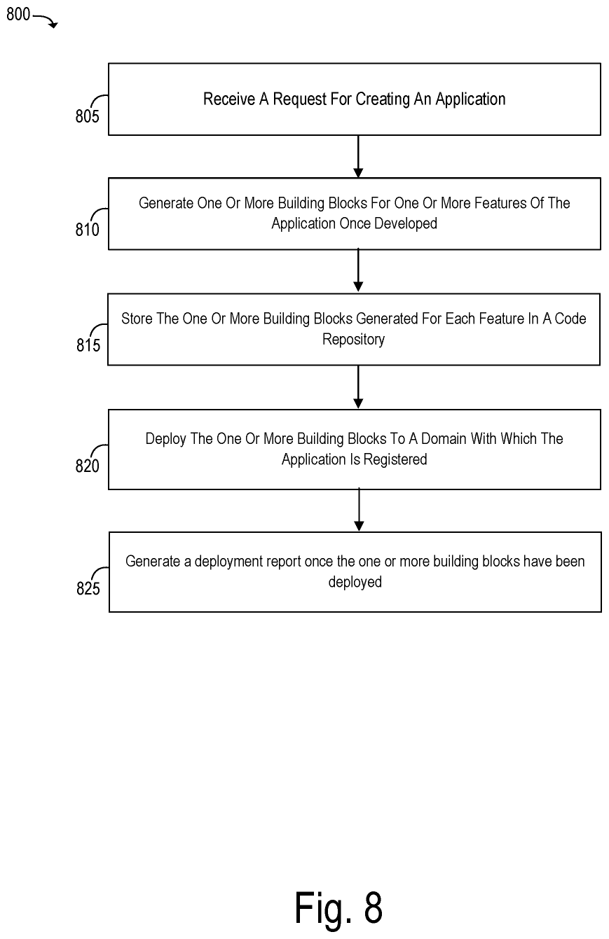

Referring to FIG. 8, FIG. 8 is a flow diagram 800 of an embodiment of the disclosed subject matter. The flow diagram 800 illustrates a method for capturing deployment details of an application. The software application may be any executable process on a computer system comprising instructions, designs, art, user interfaces, audio recordings, music, video, and the like. The software application is not limited to any commercial or consumer application. For example, the software application may be a utility application, a production application, a document generator, a game, and artistic application, and accounting application, or the like. Steps 805-825 of the flow diagram 800 may be executed using the server 605 of FIGS. 6-7. Each step is explained in further detail below.

At step 805, a request for creating an application is received from one or more developers 610, one or more designers 615, or one or more users 620. The request includes one or more features. In an example, the one or more features may include a login screen, dashboard, login page, and the like. Once the request is received and the one or more features are finalized, the one or more developers 610 and one or more designers 615 to develop the application requested are assigned.

At step 810, one or more building blocks for the one or more features selected by the one or more users 620 are generated. One building block is generated for each feature. Each building block is generated once the development of its corresponding feature is complete. The one or more building blocks are reusable pieces of code that implement partial functionalities of the one or more features assigned for each application. For example, the code may be written using C language, C++, Java, Phyton, or any appropriate programming language that is known to those skilled in the art.

At step 815, the one or more building blocks generated in step 810 are stored in a code repository. The code repository is used for managing and organizing a projects codebase and may be accessible to one or more developers 610 who are working or who have worked on the applications/projects assigned to them.

At step 820, the one or more building blocks generated in step 815 are deployed to a domain with which the application is registered. In order for the building blocks to be deployed, the application has to be registered with an appropriate domain. Deployment of the application is performed once it has been tested and is ready for launch. Once the application has been fully tested, it is then deployed to the live environment where the one or more users 620 and other persons would be able to view and experience the application.

At step 825, a deployment report is generated once the one or more building blocks generated have been deployed to the domain in step 820. The deployment report may be generated in real-time or as soon as each building block has been deployed into the live application. The deployment report includes one or more details corresponding to each deployment conducted in step 820. In an example, the one or more details may include a deployment average duration during a specified duration, a deployment total duration during a specified duration, a deployment count during a specified duration, a deployment location during a specified duration, device used for deployment, and the like. Further, the generated deployment report may be presented to the developers 610, designers 615, and users 620 via a tabular format, line graph, bar graph, pie chart, and the like.

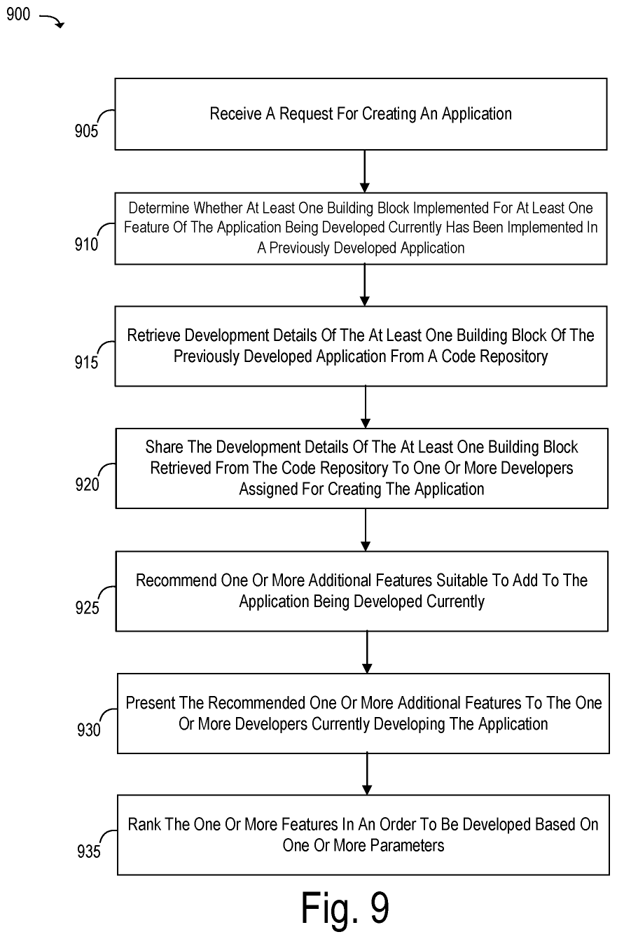

Referring to FIG. 9. FIG. 9 is a flow diagram 900 of an embodiment of the disclosed subject matter. The flow diagram 900 illustrates a method for developing an application. Steps 905-935 of the flow diagram 900 may be executed using the server 605 of FIGS. 6-7. Each step is explained in further detail below.

At step 905, a request for creating an application is received from one or more developers 610, one or more designers 615, or one or more users 620. The request includes one or more features and one or more building blocks that implement the one or more features. Once the request is received and the one or more features are finalized, the one or more developers 610 and one or more designers 615 to develop the application requested are assigned. Further, each building block is generated once the development of its corresponding feature is complete. The one or more building blocks are reusable pieces of code that implement partial functionalities of the one or more features assigned for each application.

At step 910, a determination is made whether at least one building block implemented for at least one feature of the application being developed currently has been implemented in a previously developed application. An analysis of the current development details of the at least one feature is performed and compared with development details of the same/similar feature previously developed. The development details of the at least one feature between the current application and previously developed application are then compared to determine matches.

At step 915, development details of the at least one building block of the previously developed application is retrieved from a code repository in case the development details of the at least one feature between the current application and previously developed are similar or matching.

At step 920, the development details of the building block corresponding to the previously developed login feature retrieved from the code repository is shared with the one or more developers 610. The one or more developers 610 may then use these development details while developing the same feature in their current application.

At step 925, one or more additional features to add to the application are recommended to the one or more developers 610. The one or more additional features may be recommended to the one or more developers 610 while they are working or after they have partially or completely developed at least one feature for the application. These additional features recommendations may be made based on an analysis of one or more parameters. For instance, the one or more parameters may include current trends, previously developed applications, feedback from clients/customers, costs, value to the application, and the like.

At step 930, the one or more additional features recommended in step 925 are presented to the one or more developers 610. The one or more additional features may be presented to the one or more developers 610 while they are working on the application or after the application has been developed. In an example, the recommended additional features may be presented to the one or more developers 610 via a written message, voice message, an email message, and the like simultaneously while they are working.

At step 935, the one or more features (including the additional features recommended in step 925) are ranked in an order to be developed based on one or more parameters. The one or more parameters analyzed for ranking the one or more features may include a value/importance of the feature, a value of the application, a deadline for developing the application, and the like.

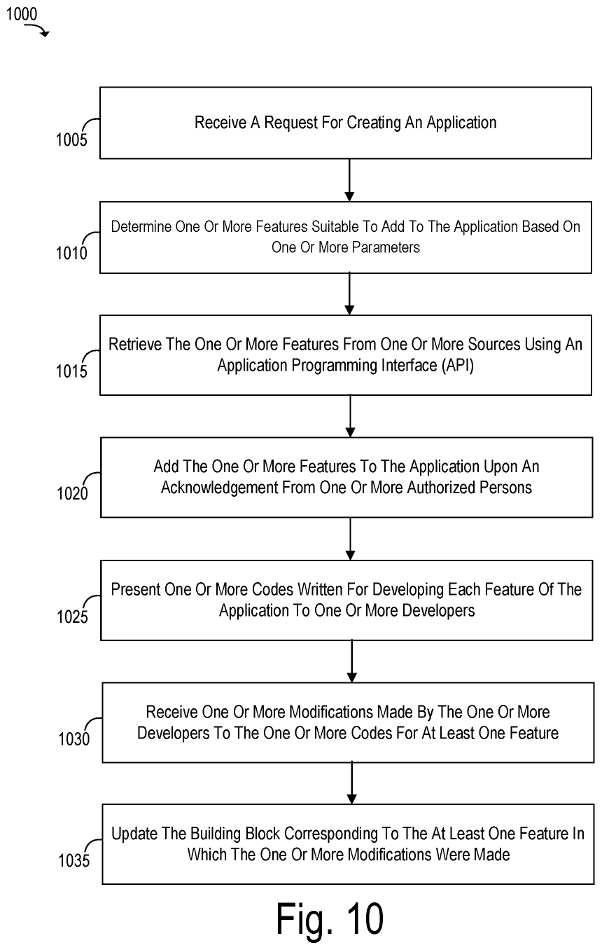

Referring to FIG. 10, FIG. 10 is a flow diagram 1000 of an embodiment of the disclosed subject matter. The flow diagram 1000 illustrates a method for obtaining features for developing an application. Steps 1005-1035 of the flow diagram 1000 may be executed using the server 605 of FIGS. 6-7. Each step is explained in further detail below.

At step 1005, a request for creating an application is received from one or more developers 610, one or more designers 615, or one or more users 620. The request includes one or more features and one or more building blocks that implement the one or more features. Further, each building block is generated once the development of its corresponding feature is complete. The one or more building blocks are reusable pieces of code that implement partial functionalities of the one or more features assigned for each application.

At step 1010, one or more features suitable to add to the application are recommended to the one or more developers 610. The one or more features may be recommended based on an analysis of one or more parameters. For instance, the one or more parameters may include current trends, previously developed applications, feedback from clients/customers, costs, value to the application, and the like.

At step 1015, the one or more features recommended in step 1010 are received from one or more sources using an application programming interface (API). In an example, the APIs may include open APIs, partner APIs, internal APIs, composite APIs, and the like. The API first retrieves information from the application requested in step 1005. Upon retrieval of the information, the API makes a call to the third-party source. Upon acknowledgement, the third-party source provides the information corresponding to the additional recommended features.

At step 1020, the one or more features recommended and retrieved in step 1015 are added to the application upon verification by the one or more developers 610. The additional features may be added to the application upon an acknowledgement from one or more authorized persons. In an example, the one or more authorized persons may be the one or more users 620. The one or more developers 610 communicate the additional features recommended by the feature recommendation module 660 and their strategy to implement these additional features to the one or more users 620 for their thoughts and acknowledgement to proceed. Upon their consent, the one or more developers 610 may add the additional features to the application.

At step 1025, the one or more codes/development codes for each building block corresponding to each feature are shared with the one or more developers 610, one or more designers 615, and one or more users 620. The development code may be presented to the one or more developers 610 or one or more designers 615 simultaneously while they are working or after the feature has been partially developed or completely developed.

At step 1030, one or more modifications made by the one or more developers 610 to at least one code for at least one feature is received. In an example, the one or more modifications may include adding new lines of code, removing previously inserted lines of code, adding new comments in the code, making changes in the functionality of the code, and the like. The one or more modifications made by the one or more developers 610 are then presented to the one or more users 620.

At step 1035, the building block corresponding to the feature in which the code has been modified is updated once the one or more modifications have been implemented. This updated building block is then automatically saved in the code repository. In an example, if feature A is modified then the building block A corresponding to feature A is modified. When saved in the code repository, the building block may be named as building block A1. Here, the code repository saves different versions of updates made in the building blocks for its corresponding features.

The system and method described herein is capable of capturing/analyzing deployment details and summarizing these captured/analyzed deployment details in a deployment report once each building block of the application has been deployed. The generated deployment report may be presented in a user-friendly manner using a tabular format, line graph, bar graph, pie chart, and the like. Such presentations allow the developers and users to visualize a deployment pattern and figure out which deployments are taking longer than expected. Thus, the system and method described herein presents the deployment details for multiple blocks and features of different applications in a transparent manner.

The system and method described herein is capable of analyzing and determining whether at least one building block implemented for at least one feature of the application being developed currently has been implemented in a previously developed application. If a similarity between the building blocks is determined, the development details of the building block developed in the previously developed application is retrieved from a code repository storing multiple building blocks and shared with developers developing the current application. These developers may then use these development details while developing the feature in their current application. Thus, the developers do not have to start from scratch as they will be provided with the previously developed details. This will save their time and effort while developing the features in the current application.

The system and method described herein further recommends one or more additional features to the developers to add to the current application being developed. These recommended features may be presented to the developers via a written message, voice message, an email message, and the like simultaneously while they are working. The written message may be presented using a chat bot and the voice message may be spoken to the developers while they are working or after they have completed a portion of the application. Such a presentation of the recommended features may help in grabbing the attention of the developers more quickly. Further, the system and method described herein in capable of receiving/retrieving one or more features recommended to the developers for adding to the application using APIs. This enables quick retrieval of the feature with minimal customer/developer/user intervention.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and such modifications are considered to be within the scope of the present disclosure.

The embodiments herein and the various features and advantageous details thereof are explained with reference to the non-limiting embodiments in the following description. Descriptions of well-known components and processing techniques are omitted so as to not obscure the embodiments herein. The examples used herein are intended merely to facilitate an understanding of ways in which the embodiments herein may be practiced and to further enable those of skill in the art to practice the embodiments herein. Accordingly, the examples may not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications may and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

Any discussion of documents, acts, materials, devices, articles or the like that has been included in this specification is solely for the purpose of providing a context for the disclosure. It is not to be taken as an admission that any of these matters form a part of the prior art base or were common general knowledge in the field relevant to the disclosure as it existed anywhere before the priority date of this application.

The numerical values mentioned for the various physical parameters, dimensions or quantities are approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the embodiments, it will be appreciated that many embodiments can be made and that many changes can be made in the embodiments without departing from the principles of the disclosure. These and other changes in the embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system for capturing deployment details of an application, the system comprising:
a processor coupled to a memory, the processor configured to:
receive a request for creating the application, wherein the request includes one or more features;
generate one or more building blocks for the one or more features once developed, wherein one building block is generated for each feature;
deploy the one or more building blocks to a domain with which the application is registered; and
generate a deployment report once the one or more building blocks have been deployed.

2. The system of claim 1, wherein the application includes at least one of a website, a mobile application, or a web application.

3. The system of claim 1, wherein the one or more building blocks are reusable pieces of code that implement functionalities of the one or more features.

4. The system of claim 1, wherein the processor is further configured to recommend one or more cloud infrastructures for deploying the one or more building blocks based on the generated deployment report.

5. The system of claim 4, wherein the processor is further configured to monitor a performance of at least one cloud infrastructure of the one or more cloud infrastructures selected by one or more developers for deploying the one or more building blocks based on one or more parameters.

6. The system of claim 5, wherein the one or more parameters include at least one of a load time of the application, a geographic location, a latency, and a bandwidth.

7. The system of claim 1, wherein the processor is further configured store the one or more building blocks generated for each feature in a code repository.

8. A method for capturing deployment details of an application, the method comprising:
receiving a request for creating the application, wherein the request includes one or more features;
generating one or more building blocks for the one or more features once developed, wherein one building block is generated for each feature;
deploying the one or more building blocks to a domain with which the application is registered with; and
generating a deployment report once the one or more building blocks have been deployed.

9. The method of claim 8, wherein the application includes at least one of a website, a mobile application, or a web application.

10. The method of claim 8, wherein the one or more building blocks are reusable pieces of code that implement functionalities of the one or more features.

11. The method of claim 8, further comprising recommending one or more cloud infrastructures for deploying the one or more building blocks based on the generated deployment report.

12. The method of claim 11, further comprising monitoring a performance of at least one cloud infrastructure of the one or more cloud infrastructures selected by one or more developers for deploying the one or more building blocks based on one or more parameters.

13. The method of claim 12, wherein the one or more parameters include at least one of a load time of the application, a geographic location, a latency, and a bandwidth.

14. The method of claim 8, further comprising storing the one or more building blocks generated for each feature in a code repository.

15. A computer readable storage medium having data stored therein representing software executable by a computer, the software comprising instructions that, when executed, cause the computer readable storage medium to perform:
receiving a request for creating an application, wherein the request includes one or more features;
generating one or more building blocks for the one or more features once developed, wherein one building block is generated for each feature;
deploying the one or more building blocks to a domain with which the application is registered with; and
generating a deployment report once the one or more building blocks have been deployed.

16. The computer readable storage medium of claim 15, wherein the application includes at least one of a website, a mobile application, or a web application.

17. The computer readable storage medium of claim 15, wherein the one or more building blocks are reusable pieces of code that implement functionalities of the one or more features.

18. The computer readable storage medium of claim 17, wherein the instructions further cause the computer readable storage medium to perform recommending one or more cloud infrastructures for deploying the one or more building blocks based on the generated deployment report.

19. The computer readable storage medium of claim 18, wherein the instructions further cause the computer readable storage medium to perform monitoring a performance of at least one cloud infrastructure of the one or more cloud infrastructures selected by one or more developers for deploying the one or more building blocks based on one or more parameters.

20. The computer readable storage medium of claim 15, wherein the one or more parameters include at least one of a load time of the application, a geographic location, a latency, and a bandwidth.
